(19) United States
(12) Patent Application Publication
(10) Pub. No.: US 2014/0364263 A1
(43) Pub. Date: Dec. 11, 2014

(54) MOTOR

(71) Applicant: Komatsu Ltd., Tokyo (JP)

(72) Inventors: Hiroyuki Tokunaga, Hiratsuka-shi (JP); Kazuhiro Okamoto, Hitachinaka-shi (JP); Akira Okabe, Naka-gun (JP)

(21) Appl. No.: 14/366,069

(22) PCT Filed: Nov. 14, 2012
(86) PCT No.: PCT/JP2012/079553

§ 371 Date: Jun. 17, 2014

(30) Foreign Application Priority Data
Mar. 14, 2012 (JP) 2012-056650

(51) Int. Cl. H02K 5/10; F16C 33/78; F16C 35/063; H02K 9/00; F16H 57/04; F16H 57/08; H02K 7/08; H02K 7/116; F16C 19/04; F16C 37/00

(52) U.S. Cl. CPC H02K 5/10; F16C 19/04; F16C 33/7806; F16C 35/063; F16C 37/007; F16H 57/04; F16H 57/08; H02K 7/086; H02K 7/116; H02K 9/00
USPC 475/149; 310/90

(57) ABSTRACT

A motor having an annular stator mounted to an inner side of a tubular housing and a rotor core disposed inward of the stator in a radial direction of the stator, includes: a shaft which is mounted to the rotor core, and which extends in a direction of a rotation center axis of the rotor core, a gear being able to be mounted on one end side of the shaft; a bearing which rotatably supports the shaft to the housing on a side of the gear than the rotor core; a tubular collar which is mounted to an outer peripheral section of the shaft and between the bearing and the gear; and a bearing mounting member which is mounted to an inner side of the housing from a side of the rotor core and mounts the bearing to the housing.

### FIELD

The present invention relates to a motor.

### BACKGROUND

A motor is used for various applications for travel of a vehicle. An output of the motor is often transmitted through a gear (e.g., Patent Literature 1),

### CITATION LIST

### Patent Literature

Patent Literature 1: Japanese Laid-open Patent Publication No. 2007-178436

### SUMMARY

### Technical Problem

In a case where an output of a motor is transmitted to a speed reduction device, a shaft mounted to a gear is oscillated by vibration or the like, thereby generating thrust force in a rotation center axis direction of the gear. Particularly, since vibration of a construction machine is large, the aforementioned thrust force becomes large. Further, in a case where a helical gear is mounted to the shaft, thrust force in a rotation center axis direction of the helical gear is generated due to rotation of the helical gear. In a case where the gear is mounted to the shaft rotating together with a rotor core of the motor, there is a possibility that a backlash is generated between a bearing and the shaft by thrust force generated due to the rotation of the gear. An object of the present invention is to reduce generation of the backlash between the bearing and the shaft caused by the thrust force.

### Solution to Problem

According to the present invention, a motor having an annular stator mounted to an inner side of a tubular housing and a rotor core disposed inward of the stator in a radial direction of the stator, comprises: a shaft which is mounted to the rotor core, and which extends in a direction of a rotation center axis of the rotor core, a gear being able to be mounted on one end side of the shaft; a bearing which rotatably supports the shaft to the housing on a side of the gear than the rotor core; a tubular collar which is mounted to an outer peripheral section of the shaft and between the bearing and the gear; and a bearing mounting member which is mounted to an inner side of the housing from a side of the rotor core and mounts the bearing to the housing.

In the present invention, it is preferable that a sealing member is provided at an outer peripheral section of the collar.

In the present invention, it is preferable that the collar has a passage which extends from an inner peripheral section of the collar to the outer peripheral section of the collar.

In the present invention, it is preferable that a sealing member is provided at an outer peripheral section of the collar, and the collar has a passage which extends from an inner peripheral section of the collar to the outer peripheral section of the collar, and an opening section of the passage on a side of the outer peripheral section is connected between the bearing and the sealing member.

In the present invention, it is preferable that a space between the two sealing members is connected to a gas reservoir.

In the present invention, it is preferable that the two sealing members are provided in the direction of the rotation center axis.

In the present invention, it is preferable that a speed reduction device is mounted to the housing, and the gear is an input section of the speed reduction device.

In the present invention, it is preferable that the speed reduction device has a planetary gear unit, and the gear is a sun gear of the planetary gear unit.

According to the present invention, a motor having an annular stator mounted to an inner side of a tubular housing and a rotor core disposed inward of the stator in a radial direction of the stator, comprises: a shaft which is mounted to the rotor core, and which extends in a direction of a rotation center axis of the rotor core, a gear being able to be mounted on one end side of the shaft; a bearing which rotatably supports the shaft to the housing further on a side of the gear than the rotor core; a tubular collar which is mounted to an outer peripheral section of the shaft and between the bearing and the gear and which has a passage extending from an inner peripheral section to an outer peripheral section; a bearing mounting member which is mounted to an inner side of the housing from a side of the rotor core and mounts the bearing to the housing; and a sealing member which is provided between the collar and the housing and suppresses a flow of a fluid between the housing and an outside of the housing, wherein an opening section of the passage on the outer peripheral section side of the collar is connected between the bearing and the sealing member.

In the present invention, it is preferable that an inside of the housing is cooled by a cooling medium.

The present invention is capable of reducing the generation of the backlash between the bearing and the shaft caused by the thrust force.

### BRIEF DESCRIPTION OF DRAWINGS

FIG. 1 is a cross-sectional view illustrating a motor according to a present embodiment.

FIG. 2 is an enlarged view of a shaft on one end side held by the motor according to the present embodiment.

FIG. 3 is a perspective view of a collar held by the motor according to the present embodiment.

FIG. 4 is a perspective view of the collar held by the motor according to the present embodiment.

FIG. 5 is an explanatory diagram illustrating a wheel loader.

FIG. 6 is an exemplary diagram illustrating a drive system of the wheel loader.

### DESCRIPTION OF EMBODIMENTS

A mode for carrying out the present invention (embodiment) will be described in detail referring to the drawings. The present invention is not limited by a content described in the following embodiment. Further, components described below include matters that can be easily assumed by those skilled in the art and substantially identical matters. Furthermore, the components described below can be appropriately combined. Moreover, various omissions, substitutions and changes can be made in the components without departing from the gist of the present invention. Next, a motor according to the present embodiment will be described.

<Motor>

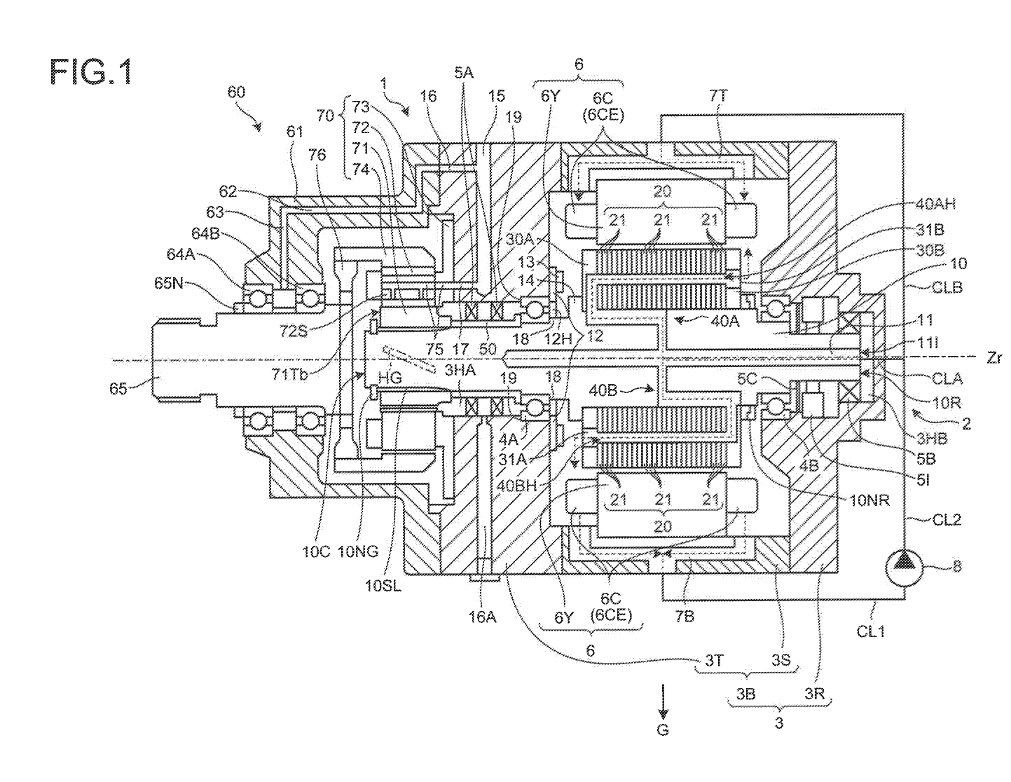

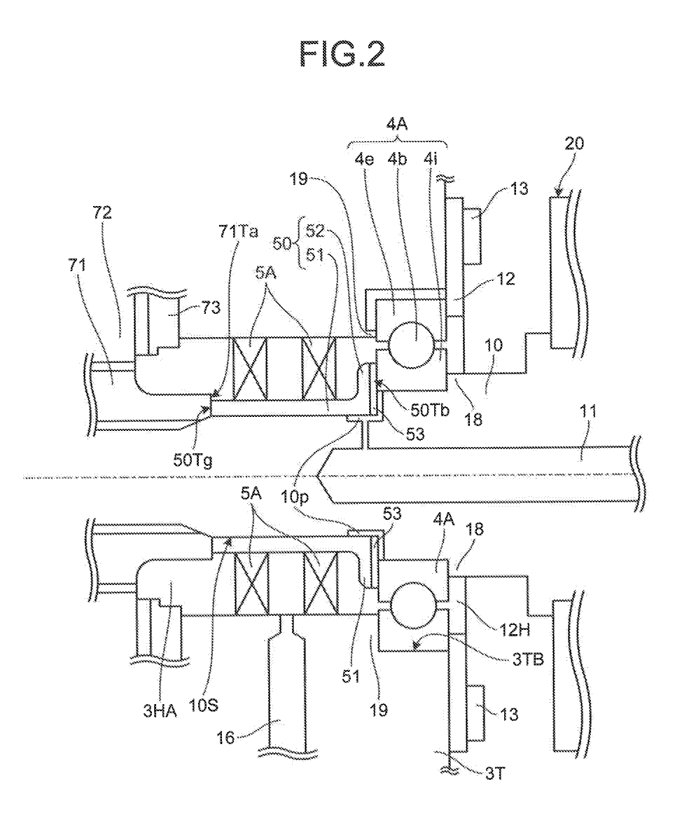

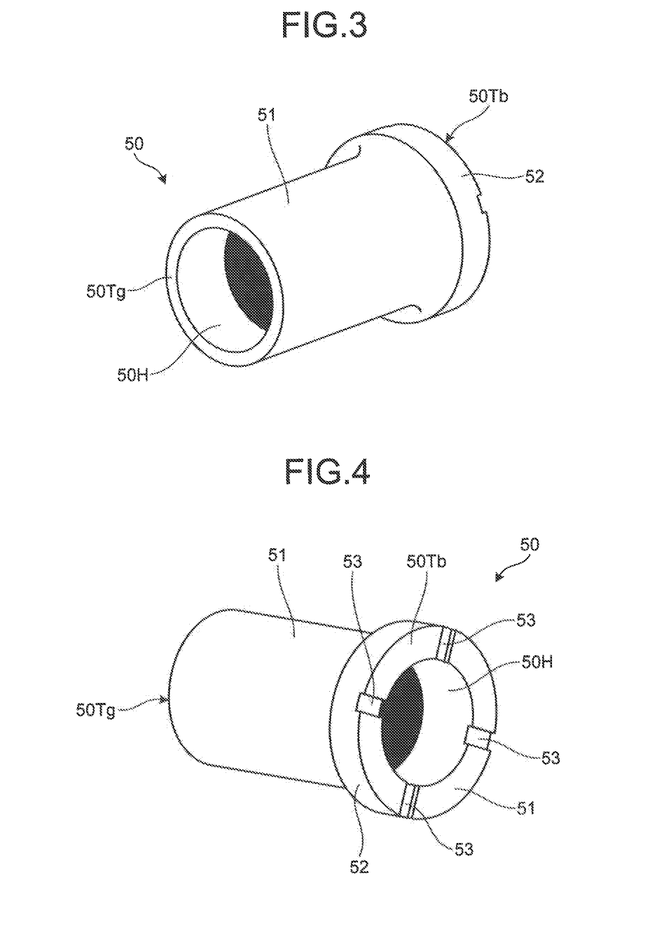

FIG. 1 is a cross-sectional view illustrating the motor according to the present embodiment. FIG. 2 is an enlarged view of a shaft on one end side held by the motor according to the present embodiment. FIG. 3 and FIG. 4 are perspective views of a collar held by the motor according to the present embodiment. A motor 1 includes a housing 3, a shaft 10 serving as a power transmission shaft, a rotor core 20, and a stator 6. The rotor core 20, the shaft 10 to which the rotor core 20 is mounted, and the stator 6 are stored inside of the housing 3. The housing 3 has a cylindrical structure. In the present embodiment, the housing 3 has a disk-shaped shaft taking out side member 3T, a cylindrical side section 3S, a disk-shaped anti-shaft taking out side member 3R. A space surrounded by the shaft taking out side member 3T, the side section 3S, and the anti-shaft taking out side member 3R becomes an inside of the housing 3.

The shaft taking out side member 3T has a through-hole 3HA for taking out the shaft 10 to an outside of the housing 3. The shaft 10 stored inside of the housing 3 is taken out from the through-hole 3HA. In the present embodiment, the shaft taking out side member 3T and the side section 3S are manufactured as separate members, and then the two are joined by a fastening member, such as a screw. However, for example, the two may be integrally molded by casting or the like. The anti-shaft taking out side member 3R is mounted to an end of the side section 3S, which is on a side opposite to the shaft taking out side member 3T. The anti-shaft taking out side member 3R is mounted to the side section 3S by a fastening member, such as a screw. The shaft taking out side member 3T also serves as a partition which separates lubrication oil lubricating a speed reduction device 60, to be described below, and a cooling medium inside of the housing 3.

The annular stator 5 is mounted to an inner side of the housing 3, more specifically to an inner periphery of the side section 3S. The stator 6 is mounted over an entire periphery of the inner periphery of the side section 3S. The rotor core 20 is disposed inward of the stator 6 in a radial direction thereof. In the present embodiment, the rotor core 20 has a cylindrical structure, on which disk-shaped steel sheets (electromagnetic steel sheets) 21 are laminated. A plurality of permanent magnets is embedded inside the rotor core 20. In this way, in the present embodiment, the motor 1 has an IPM (Interior Permanent Magnet). However, the motor 1 may have an SPM (Surface Permanent Magnet). The rotor core 20 rotates around a rotation center axis Zr.

The stator 6 has an annular structure having a stator core 6Y and a coil 6C, and the coil 6C is wound around the stator core 6Y. A part of the coil 6C, which protrudes from the stator core 6Y, is a coil end 6CE. The stator core 6Y has a structure, on which a plurality of steel sheets (electromagnetic steel sheets) is laminated. It should be noted that the motor 1 may be a motor having no permanent magnet, for example, an induction motor.

The rotor core 20 has a structure, in which the plurality of steel sheets 21 is mounted to the shaft 10 and laminated. In a state in which the plurality of steel sheets 21 is mounted to the shaft 10, a direction in which the plurality of steel sheets 21 is laminated (laminating direction) is an axis direction of the shaft 10, i.e., a direction parallel to the rotation center axis Zr. Balance plates 30A, 30B are provided at each end of the rotor core 20 in the laminating direction. The balance plates 30A, 30B are annular members and mounted to outer peripheral sections of the shaft 10. The rotor core 20, on which the plurality of steel sheets 21 is laminated, is sandwiched between the two balance plates 30A, 30B. On the one balance plate 30A side, the shaft 10 has a rotor core fixing section 14 whose outer diameter is larger than an inner diameter of the balance plate 30A. With this configuration, when the balance plate 30A, which has been mounted to the shaft 10 from another end 10R side of the shaft 10 abuts the rotor core fixing section 14, further movement is regulated. By mounting the balance plate 30A, the rotor core 20, the balance plate 30B to the shaft 10 in this turn and screwing a rotor core fixing nut 10NR to the shaft 10, the rotor core 20 is mounted to the shaft 10. In this state, the balance plates 30A, 30B apply compression force to the rotor core 20, i.e., the above-described plurality of laminated steel sheets 21. Diameters of the balance plates 30A, 30B are equal to a diameter of the steel sheet 21 or smaller than the diameter of the steel sheet 21.

The shaft 10 is mounted to the rotor core 20. The shaft 10 extends in the rotation center axis Zr of the rotor core 20, and a gear 71 is capable of mounting to one end 10C side. In the present embodiment, the gear 71 is a helical gear. However, it is not limited to this, and may be a spur gear. The shaft 10 is in charge of an output from the motor 1 and an input to the motor 1. In the present embodiment, the gear 71 of the speed reduction device 60 is mounted to the shaft 10 on the one end 10C side thereof. The shaft 10 shares the rotation center axis Zr with the rotor core 20, and rotates around the rotation center axis Zr together with the rotor core 20. In this way, the shaft 10 outputs power generated at the motor 1 to an outside of the motor 1, or inputs power to the motor 1 in a case where the motor 1 is used as a generator. The gear 71 mounted to the shaft 10 also rotates around the rotation center axis Zr of the shaft 10 together with the shaft 10. The gear 71 is a gear having a tooth (helical tooth) HG inclined to the rotation center axis Zr, as viewed from a direction orthogonal to the rotation center axis Zr.

In a case where the motor 1 is used for traveling of a construction machine, such as a wheel loader, it is preferable that the motor 1 be miniaturized by rotating at high speed. In this case, the output of the motor 1 is input to a transmission device 107 via the speed reduction device 60. In a case where the motor 1 is rotated at high speed (e.g., 10000 rpm or more), noise increases in a case of the spur gear. Because of this, noise of the speed reduction device 60 is suppressed by mounting the gear 71 to the shaft 10 and inputting the output of the motor 1 to the speed reduction device 60.

Bearings 4A, 4B are respectively mounted to each side of the shaft 10. In the present embodiment, both of the bearings 4A, 4B are ball bearings. The two bearings 4A, 4B are mounted to the housing 3 and rotatably support the shaft 10. In the present embodiment, the bearing 4A is mounted to the shaft taking out side member 3T, and the bearing 4B is mounted to the anti-shaft taking out side member 3R, which is on the side opposite to the shaft taking out side member 3T. In other words, the bearing 4A rotatably supports the shaft 10 relative to the housing 3 further on the gear 71 side than the rotor core 20, and the bearing 4A rotatably supports the shaft 10 relative to the housing 3 further on the other end 10R side than the rotor core 20. With this construction, the housing 3 rotatably supports the shaft 10 via the bearings 4A, 4B. In the following description, the hearing 4A is referred to as “first bearing 4A” and the bearing 4B is referred to as “second bearing 4B”, as necessary. A spline 10SL is formed on an outer peripheral surface of the shaft 10 on the one end 10C side.

The one end 10C of the shaft 10 protrudes from the through-hole 3HA of the shaft taking out side member 3T. As described above, the gear 71 is mounted to the shaft 10 on the one end 10C site thereof. A spline, which is connected with the spline 10SL formed at the shaft 10 on the one end 10 side thereof, is formed on an inner peripheral surface of the gear 71, and the two splines mesh with each other. With this configuration, the power of the motor 1 is taken out from the shaft 10, or the power is generated from the motor 1 by inputting the power to the motor 1 via the gear 71. The one end 10C side of the shaft 10 serves as the input/output side of the shaft 10.

In the present embodiment, the speed reduction device 60 is mounted to the housing 3 of the motor 1. The speed reduction device 60 is a device which reduces a rotation speed of the shaft 10 of the motor 1, increases torque thereof, and outputs the rotation speed from an output section. An input section of the speed reduction device 60 is the gear 71 mounted to the shaft 10 of the motor 1. The input section of the speed reduction device 60 is a section, to which the power from a power source, such as the motor 1, is input. The speed reduction device 60 reduces and then outputs the rotation speed of the shaft 10 using a planetary gear unit 70. The speed reduction device 60 is not limited to the one using the planetary gear unit 70.

The planetary gear unit 70 is stored in a housing 61 of the speed reduction device 60. The housing 61 of the speed reduction device 60 is mounted to the housing 3, the shaft taking out side member 3T in the present embodiment, of the motor 1. The planetary gear unit 70 has the gear 71 serving as a sun gear, a plurality of pinion gears 72 meshing with the gear 71, a carrier 73, to which a pinion shaft 72S rotatably supporting the plurality of pinion gears 72 is mounted, and a ring gear 74 meshing with the plurality of pinion gears 72. As described above, the internal teeth formed on the inner peripheral surface of the gear 71 is a spline which is connected to the spline SL of the shaft 10, and external teeth thereof are helical teeth. The plurality of pinion gears 72 is disposed between the gear 71 and the ring gear 74.

By fitting a pin driven into the shaft taking out side member 3T of the motor 1 and a hole provided at the carrier 73, for example, the carrier 73 is mounted to the shaft taking out side member 3T so as not to relatively rotate around the rotation center axis Zr. In this way, in the speed reduction device 60, the carrier 73 of the planetary gear unit 70 is fixed, and the input from the gear 71 serving as the sun gear is output from the ring gear 74 via the pinion gears 72. The ring gear 74 serves as an output section of the speed reduction device 60. In the speed reduction device 60, the ring gear 74 may be fixed, and the carrier 73 may serve as the output section.

The ring gear 74 has a connecting member 76 at an end where a distance from the motor 1 is longer. The connecting member 76 is connected to a power transmission shaft 65 of the speed reduction device 60. The power transmission shaft 65 is rotatably supported by the housing 61 of the speed reduction device 60 via two speed reducer bearings 64A, 64B mounted to the power transmission shaft 65. By screwing a bearing fixing nut 65N to the power transmission shaft 65, the speed reducer bearings 64A, 64B are mounted to the power transmission shaft 65. The power transmission shaft 65, for example, is connected to an input section of a transmission device of a construction machine, such as a wheel loader.

The housing 61 of the speed reduction device 60 has a lubrication oil passages 62, 63, which supply lubrication oil (fluid) for lubricating the speed reducer bearings 64A, 64B and the planetary gear unit 70. The lubrication oil passages 62, 63 receive supply of the lubrication oil from lubrication oil passages 15, 16 held by the housing 3, the shaft taking out side member 3T in the present embodiment, of the motor 1. Further, the carrier 73 and the pinion shaft 72S mounted to the carrier 73 of the planetary gear unit 70 have a lubrication oil passage 75, which receives supply of the lubrication oil from a lubrication oil passage 17 held by the shaft taking out side member 3T. The lubrication oil passage 75 supplies the lubrication oil between the pinion gears 72 and the gear 71.

As illustrated in FIG. 1 and FIG. 2, a tubular, more specifically cylindrical, collar 50 is mounted to an outer peripheral section 10S of the shaft 10 and between the first bearing 4A and the gear 71. As illustrated in FIG. 3 and FIG. 4, the collar 50 has a body section 51 and a flange section 52, which is provided at one end of the body section 51 and protrudes outward in a radial direction. An end (flange side end) 50Tb on a flange section 52 side faces the first bearing 4A, and an end (anti-flange side end) 50Tg on a side opposite to the flange section 52 faces the gear 71. As illustrated in FIG. 3 and FIG. 4, the collar 50 has a through-hole 50H which penetrates from the flange side end 50Tb to the anti-flange side end 50Tg. The shaft 10 is fitted into the through-hole 50H. The collar 50 and the shaft 10 are mounted by interference fit, and the two are integrally rotated around the rotation center axis Zr.

In the present embodiment, a material of the shaft 10 is, for example, chrome molybdenum steel, and a material of the collar 50 is, for example, carbon steel. In this way, in the present embodiment, different materials are used for the shaft 10 and the collar 50. By doing so, materials which are suitable for functions of the shaft 10 and the collar 50 can be selected. For example, in the present embodiment, a material which is suitable for power transmission is selected for the shaft 10. The function of power transmission is not required for the collar 50, but as described below, a material which is suitable for forming a sealing surface for realizing a function of sealing a cooling medium and lubrication oil as fluid is selected for the collar 50.

The first bearing 4A abuts a bearing locking section 18, which protrudes outward in a radial direction from the outer peripheral section 10S of the shaft 10. In the present embodiment, as illustrated in FIG. 2, an inner ring 4i of the first bearing 4A abuts the bearing locking section 18. Further, the flange side end 50Tb of the collar 50 mounted to the shaft 10 abuts the inner ring 4i of the first bearing 4A. The anti-flange side end 50Tg of the collar 50 abuts one end 71Ta of the gear 71 mounted to the shaft 10 on the one end 10C side thereof. Then, as illustrated in FIG. 1, a gear retaining ring 10NG is mounted to the shaft 10 from the one end 10C side of the shaft 10. The gear retaining ring 10NG abuts another end 71Tb of the gear 71. By mounting the gear retaining ring 10NG to the shaft 10, the first bearing 4A, the collar 50, and the gear 71 are mounted to the shaft 10 between the gear retaining ring 10NG and the bearing locking section 18. As described above, the gear 71 and the shaft 10 are, for example, connected by the spline, and positioning of the two in the circumferential direction is performed. Further, a slight gap is formed between the gear retaining ring 10NG and the gear 71. This gap allows movement of the gear 71 in a direction of the rotation center axis Zr.

An outer ring 4e of the first bearing 4A is mounted to a bearing mounting section 3TB provided at the shaft taking out side member 3T. The bearing mounting section 3TB is a circular hole formed at the shaft taking out side member 3T. An inner diameter of the bearing mounting section 3TB is larger than an inner diameter of the through-hole 3HA, and both the bearing mounting section 3TB and the through-hole 3HA are connected to each other. As a result, a step section 19 is formed at a connecting section between the bearing mounting section 3TB and the through-hole 3HA. In the first bearing 4A mounted to the bearing mounting section 3TB, the outer ring 4e abuts the step section 19. In a state in which the first bearing 4A is mounted to the bearing mounting section 3TB, a bearing mounting member 12 is mounted to the shaft taking out side member 3T. The bearing mounting member 12 is mounted to the shaft taking out side member 3T by a bolt 13 serving as fastening means.

The shaft 10 penetrates through a through-hole 12H of the hearing mounting member 12, and the bearing mounting member 12 is mounted to the inner side of the housing 3, an inner side of the shaft taking out side member 3T in the present embodiment, from the rotor core 20 side. An inner diameter of the through-hole 12H is smaller than an outer diameter of the outer ring 4e of the first bearing 4A and larger than an inner diameter of the outer ring 4e thereof. Because of this, the bearing mounting member 12 faces only the outer ring 4e of the first bearing 4A. Accordingly, even if the bearing mounting member 12 is mounted to the shaft taking out side member 3T, since the bearing mounting member 12 does not interfere with the inner ring 4i and a rolling body 4b, the bearing mounting member 12 does not hinder these movements. With this configuration, the first bearing 4A is mounted to the shaft taking out side member 3T by the bearing mounting member 12.

The bearing mounting member 12 is provided in a form of protruding from the shaft taking out side member 3T to the outer ring 4e side (the shaft 10 side relative to the stator 6) of the first bearing 4A. Then, the bearing mounting member 12 is mounted in such a manner that a surface thereof on the shaft taking out side member 3T side is flush with an end surface of the outer ring 4e. By doing so, movement of the first bearing 4A is regulated. By press-fitting the collar 50 into the shaft 10, an opposite side of the first bearing 4A is positioned in such a manner that the first bearing 4A is not moved.

As illustrated in FIG. 2 and FIG. 4, the collar 50 has a groove 53 serving as a passage which extends from an inner peripheral section of the collar 50 to the outer peripheral section thereof. In the present embodiment, the collar 50 has the groove 53 at a section which is opposite to the first bearing 4A, i.e., the flange side end 50Tb of the flange section 52. A place, at which the groove 53 is provided, is not limited to this section. As illustrated in FIG. 2, the groove 53 on an inner diameter side of the collar 50 opens to a cooling medium supply groove 10p provided in a circumferential direction of the outer peripheral section 10S of the shaft 10. In the present embodiment, an opening section of the groove 53 on the outer peripheral section side of the collar 50 is connected between the first bearing 4A and a sealing member 5A.

The cooling medium is supplied to the cooling medium supply groove 10p from a cooling medium supply passage 11 held by the shaft 10. The groove 53 rotates together with the shaft 10 and the collar 50. By discharging the cooling medium supplied from the cooling medium supply groove 10p outward of the collar 50 in a radial direction thereof, the groove 53 supplies the cooling medium to the first bearing 4A. The cooling medium cools the coil 60 held by the stator 6, the rotor core 20, and the like of the motor 1 and lubricates a sliding section. In the present embodiment, a through-hole which penetrates the collar 50 from the inner peripheral section of the collar 50 to the outer peripheral section thereof may be used as the passage which extends from the inner peripheral section of the collar 50 to the outer peripheral section thereof.

The sealing member 5A is provided at the outer peripheral section of the collar 50 mounted to the shaft 10. In the present embodiment, the sealing member 5A is provided between the collar 50 and the housing 3, more specifically the shaft taking out side member 3T. The sealing member 5A may be provided at the outer peripheral section of the collar 50, and may be provided at a place other than the one between the collar 50 and the housing 3. For example, the sealing member 5A may be provided between the collar 50 and the housing 61 of the speed reduction device 60.

A sealing member 5B is provided between the shaft 10 on the other end 10R side and the housing 3, the anti-shaft taking out side member 3R in the present embodiment. In the present embodiment, the sealing members 5A, 5B are oil seals. Further, an oil seal 5C serving as a sealing member is provided between the second bearing 4B and the sealing member 5B. An engine speed sensor 5I, which detects engine speed of the shaft 10, is provided between the shaft 10 and the housing 3, the anti-shaft taking out side member 3R in the present embodiment. It should be noted that the engine speed sensor 5I is disposed between the second bearing 4B and the sealing member 5B.

The sealing member 5A is mounted to the through-hole 3HA of the shaft taking out side member 3T, and between the first bearing 4A and the one end 10C of the shaft 10, more specifically at a position facing the collar 50. The sealing member 5B is disposed further on the other end 10R side of the shaft 10 than the second bearing 4B, and is mounted to a through-hole 3HB of the anti-shaft taking out side member 3R. In the present embodiment, an inside of the motor 1 is cooled by the cooling medium (e.g., oil) and the bearings 4A, 4B are lubricated. Consequently, the sealing members 5A, 5B are provide between the housing 3 and the shaft 10 to suppress leakage of the cooling medium from the shaft 10 to the outside of the housing 3.

In the present embodiment, since the speed reduction device 60 is mounted to the shaft taking out side member 3T of the motor 1, there is a possibility that the lubrication oil for lubricating the speed reduction device 60 enters the inside of the motor 1 (the inside of the housing 3) via the first bearing 4A adjacent to the speed reduction device 60. Since the lubrication oil of the speed reduction device 60 contains abrasion powder or the like of the planetary gear unit 70, if the oil enters the inside of the motor 1, there is a possibility that durability of the first bearing 4A, the rotor core 20, and the stator 6 is lowered. Further, in a case where the speed reduction device 60 is applied to a construction machine, such as a wheel loader, the number of operations at continuous high loads is larger than that of a case applied to a vehicle. Accordingly, there is a possibility that a temperature of the oil on the speed reduction device side is higher than heat resistant temperatures of parts configuring the motor 1, or that an amount of abrasion powder produced increases. The sealing member 5A provided at a section of the collar 50 between the motor 1 and the speed reduction device 60 reduces the possibility that the lubrication oil of the speed reduction device 60 enters the inside of the motor 1. In this way, the sealing member 5A can suppress a flow of the lubrication oil and the cooling medium serving as fluid between the housing 3 and the outside of the housing 3. As a result, the sealing member 5A is capable of reducing the possibility that the lubrication oil, which contains a large amount of abrasion powder and has a high temperature, of the speed reduction device 60 enters the inside of the motor 1, stably operating the motor 1, and suppressing lowering of durability of the motor 1.

In the present embodiment, the two sealing members 5A are provided in the direction of the rotation center axis Zr. By doing so, the sealing members 5A can suppress more effectively the possibility that the lubrication oil of the speed reduction device 60 enters the inside of the motor 1. Further, even in a case where the rotor core 20 and the shaft 10 of the motor 1 are rotated at high speed, the possibility that the lubrication oil of the speed reduction device 60 enters the inside of the motor 1 can be reliably suppressed. In the present embodiment, a space (sealing member space) between the two sealing members 5A is connected to a gas reservoir 16. The gas reservoir 16 is provided at the shaft taking out side member 3T in the present embodiment, but the gas reservoir 16 may be provided at a section other than this. The gas reservoir 16 is a section holding a constant amount of gas (air), and may be opened to the atmosphere. By connecting the sealing member space to the gas reservoir 16, even in a case where pressure within the sealing member space is changed by the rotation of the shaft 10, the above-described change of pressure is relaxed by the gas held in the gas reservoir 16. As a result, since the pressure change in the sealing member space is suppressed, a sealing function of the sealing member 5A can be maintained. Particularly, in the case where the shaft 10 is rotated at high speed, an effect of connecting the sealing member space to the gas reservoir 16 is greater. It should be noted that the number of the sealing members 5A may be one. In this case, the gas reservoir 16 may not be needed.

In the present embodiment, the gear 71 is mounted to the shaft 10 on the one end 10C side. Then, the shaft 10 transmits power from the gear 71 to the speed reduction device 60, and transmits the power from the speed reduction device 60 to the motor 1 via the gear 71. When the wheel loader or the like, on which the speed reduction device 60 and the motor 1 are mounted, is traveled or operated, vibration is generated. Due to this vibration, thrust force is generated in the shaft 10 of the motor 1. Further, in a case where the gear 71 is a helical gear, when the gear 71 rotates, thrust force caused by rotation of the helical gear is generated in addition to the above-described thrust force caused by the vibration. The above-described thrust force can move the first bearing 4A or the second bearing 4B in the direction of the rotation center axis Zr via the shaft 10 and more the rotor core 20 in the direction of the rotation center axis Zr along with this. Because of this, there is a possibility that a backlash is generated between the first bearing 4A or the second bearing 4B and the shaft 10. In the present embodiment, the collar 50 is interposed between the gear 71 and the first bearing 4A, and the above-described thrust force is transmitted between the first bearing 4A and the gear 71 via the collar 50. Further, the first bearing 4A is mounted to the shaft taking out side member 3T by the bearing mounting member 12 from the rotor core 20 side.

With this configuration, the thrust force from the gear 71 to the first bearing 4A is transmitted to the collar 50, the first bearing 4A, and the bearing mounting member 12 in turn and received by the shaft taking out side member 3T, to which the bearing mounting member 12 is mounted. Further, the thrust force from the second bearing 4B to the first bearing 4A is transmitted to the shaft 10, the first bearing 4A, and the step section 19 in turn and received by the shaft taking out side member 3T, forming the stab section 19. Since the shaft taking out side member 3T configuring the housing 3 of the motor 1 receives the thrust force in any direction, deviations of the first bearing 4A and the second bearing 4B in the rotation center axis Zr direction caused by the thrust force can be suppressed. As a result, the backlash between the first bearing 4A or the second bearing 4B and the shaft 10 can be reduced.

Since the wheel loader frequently repeats forward and backward movements, a rotation direction of the motor 1 is also switched frequently. Because of this, since the rotation direction of the gear 71 is also switched frequently, in the case where the gear 71 is a helical gear, a direction of the thrust force acting on the shaft 10 is also switched frequently. At the time of switching of the rotation direction, since the gear 71 is moved in the rotation center axis Zr direction by an amount of play in the rotation center axis Zr direction, impact force acts on the shaft 10 as the thrust force. In the present embodiment, with the above-described configuration, the shaft taking out side member 3T configuring the housing 3 of the motor 1 receives the thrust force from the gear 71. Accordingly, even in the case where the impact force is acted as the thrust force, the shaft taking out side member 3T reliably receives the impact force, and a load to the bearing 4A, 4B can be minimized. Because of this, the motor 1 is, for example, particularly preferable to an application in which the rotation direction frequently switches, such as a travel motor of a wheel loader, and a swing motor driving an upper swing body of an excavator.

In the present embodiment, the gear 71, the collar 50, and the first bearing 4A are fixed to the shaft 10 by the one gear retaining ring 10NG. In a case where the collar 50 is not used, a nut for fixing the first bearing 4A to the shaft 10 is needed besides the gear retaining ring 10NG. Since this nut increases a dimension of the shaft 10 in the rotation center axis Zr direction, there is also a possibility that bending rigidity of the shaft 10 is reduced in addition to the dimensional increase of the motor 1 in the rotation center axis Zr direction. Further, it is necessary that a section of the shaft 10, to which this nut is screwed, has a diameter larger than a section of the shaft 10, to which the gear 71 is mounted. Because of this, when the collar 50 is not used, the diameter of the shaft 10 is increased in addition to the need for the nut other than the gear retaining ring 10NG. As a result, in the case where the collar 50 is not used moment of inertia of the shaft 10 can be increased by the increase of the diameter of the shaft 10 and the additional nut. In the present embodiment, by using the collar 50, the gear 71, the collar 50, and the first bearing 4A can be fixed to the shaft 10 by the one gear retaining ring 10NG. As a result, the dimensional increase of the motor 1 in the rotation center axis Zr direction, the lowering of the bending rigidity of the shaft 10, and the increase of the moment of inertia can be suppressed.

Moreover, in the case where the collar 50 is not used, it is considered that a section of the gear 71, in which the helical tooth is not formed, extends in the direction of the first bearing 4A and a section corresponding to the collar 50 is provided at the gear 71. In this case, it is necessary to extend a spline to a vicinity of the first bearing 4A to mount the gear to the shaft 10. Then, since the above-described spline is formed at the shaft 10 beyond the sealing member 5A, there is a possibility that the lubrication oil of the speed reduction device 60 moves to the first bearing 4A through the above-described spline. In the present embodiment, the collar 50 is mounted to the shaft 10 by the interference fit, and the sealing member 5A is disposed between the collar 50 and the shaft taking out side member 3T. Because of this, passing of the lubrication oil of the speed reduction device 60 between the collar 50 and the shaft 10 can be avoided.

Further, in the present embodiment, by using the collar 50, the gear 71, the collar 50, and the first bearing 4A can be fixed to the shaft 10 by the one gear retaining ring 10NG. Accordingly, the dimensional increase of the shaft 10 in the rotation center axis Zr direction can be suppressed. Because of this, since the lowering of the bending rigidity of the shaft 10 is suppressed, the deviation of the shaft 10 caused by the vibration generated at the time of rotation of the gear 71 is also reduced. As a result, a sealed state between the sealing member 5A and the shaft 10 can be reliably maintained. Particularly, it is advantageous in the case where the shaft 10 is rotated at high speed. Next, a cooling structure 2 of the motor 1 will be described.

<Cooling Structure of Motor>

In the motor 1, the inside of the housing 3 is cooled by the cooling medium. Because of this, as illustrated in FIG. 1, the shaft 10 has the cooling medium supply passage 11 for causing the cooling medium for cooling the inside of the motor 1 to pass through. In the present embodiment, the cooling medium supply passage 11 is provided along the rotation center axis Zr. It is preferable that the cooling medium supply passage 11 be provided on the rotation center axis Zr. Further, the shaft 10 may be a hollow shaft and have a structure which causes yet another shaft to pass through the shaft 10. In this case, a space formed between the shaft 10 and the other shaft passing through the shaft 10 can serve as the cooling medium supply passage 11. The cooling medium supply passage 11 is inside the shaft 10, and extends from the other end 10R to the axis direction of the shaft 10, i.e., the rotation center axis Zr direction. Because of this, a cooling medium inlet 11I, where the cooling medium flows into the cooling medium supply passage 11, is provided at the other end 10R of the shaft 10. In this way, the other end 10R side of the shaft 10 serves as a cooling medium inlet side.

A plurality of cooling medium passages 40A, 40B branches from the cooling medium supply passage 11. It should be noted that FIG. 1 illustrates a cross section of a case where the shaft 10 is cut by a plane parallel to the rotation center axis Zr of the shaft 10 and including the rotation center axis Zr. For convenience of description, the plurality of cooling medium passages 40A, 40B appears on the same cross section. However, in reality, the cooling medium passages 40A, 40B appear on respective cross sections of a case where the shaft 10 is cut by planes whose central angles centering around the rotation center axis Zr are different by 90 degrees.

The plurality of cooling medium passages 40A, 40B branches from the cooling medium supply passage 11, and cools the rotor core 20 while flowing the cooling medium in one direction without branching it with respect to the axis direction of the shaft 10. Then, the cooling medium is discharged from discharge ports 40AH, 40BH opening on a surface of the rotor core 20. Also a distance (passage distance) of the plurality of cooling medium passages 40A, 40B from the cooling medium inlet 11I, where the above-described cooling medium flows into the cooling medium supply passage 11, to the discharge ports 40AH, 40BH is the same. The cooling medium discharged from the discharge ports 40AH, 40BH flows out from cooling medium outlets 31B, 31A held by the balance plates 30B, 30A into the housing 3. In a case where the rotor core 20 rotates, the cooling medium flowed out from the cooling medium outlets 31B, 31A is splashed outward of the rotor core 20 in a radial direction thereof by centrifugal force caused by the above-described rotation. Then, the above-described cooling medium splashed outward in the radial direction cools the coil end 6CE.

A cooling medium recovery passage 7B is provided at the side section 3S of the housing 3. In a state in which the motor 1 is used, the cooling medium recovery passage 7B is provided at a lower position (a direction side on which gravity acts, and a direction side indicated by an arrow G in FIG. 1). For example, in a case where the motor 1 is mounted on the wheel loader, a state in which the wheel loader is grounded on a horizontal surface is assumed to be a state in which the motor 1 is used, and the cooling medium recovery passage 7B is provided at a lower position in that state.

In the present embodiment, the housing 3 has a coil end cooling passage 7T at a section facing the coil end 6CE and avoiding the cooling medium recovery passage 7B. Then, the cooling medium is also supplied from the coil end cooling passage 7T to the coil end 6CE, thereby cooling the coil end 6CE. It should be noted that the coil end cooling passage 7T is not necessarily provided. For example, based on a specification or an operating condition of the motor 1, a mounting object of the motor 1, or the like, it is determined whether the coil end cooling passage 7T is provided at the housing 3. In a case where the motor is disposed in such a manner that the rotation center axis Zr of the shaft 10 is orthogonal to a vertical direction (gravity acting direction), it is preferable that the coil end cooling passage 7T be disposed at an upper position (a side opposite to the vertical direction), and more preferably that the coil end cooling passage 7T be disposed at an uppermost, position (i.e., a top position).

In the present embodiment, the cooling medium is supplied to the motor 1 by a pump 8 serving as cooling medium circulating means and sucked by the pump 8 after the motor 1 is cooled and the like. A suction port of the pump 8 is connected with the cooling medium recovery passage 7B by a first cooling medium piping CL1. Moreover, a discharge port of the pump 8 is connected with the motor 1 by a second cooling medium piping CL2. In the present embodiment, the second cooling medium piping CL2 branches into a shaft side supply piping CLA and a coil end side supply piping CLB. The former is connected to the cooling medium inlet 11I of the cooling medium supply passage 11, and the latter is connected to the coil end cooling passage 7T, thereby supplying the cooling medium discharged from the pump 8 to each connecting object.

In the present embodiment, the cooling structure 2 includes the cooling medium supply passage 11 and the plurality of cooling medium passages 40A, 40B. The cooling medium discharged from the pump 8 passes through the second cooling medium piping CL2. A part of the cooling medium flows to the shaft side supply piping CLA, and the remainder thereof flows to the coil end side supply piping CLB. The cooling medium flowed to the shaft side supply piping CLA passes through the cooling medium inlet 11I, and then a part of the cooling medium is flowed to each cooling medium passage 40A, 40B. Then, the cooling medium cools the rotor core 20 during passing through the cooling medium passages 40A, 40B and is discharged to the inside of the housing 3 through the discharge ports 40AH, 40BH. The cooling medium discharged to the inside of the housing 3 reaches the coil end 6CE by the centrifugal force of the rotor core 20, thereby cooling the coil end 6CE. The cooling medium flowed to the coil end side supply piping CLB flows into the coil end cooling passage 7T, and is then supplied to the coil end 6CE, thereby cooling this. Even in a case where the motor 1 is operated under an operating condition that cooling of the coil end 6CE by the cooling medium flowed from the cooling medium outlets 31B, 31A easily becomes insufficient, the coil end 6CE can be cooled by the coil end cooling passage 7T. Because of this, the motor 1 can be stably operated by the coil end cooling passage 7T even under various operating conditions.

The cooling medium cooled the coil end 6CE and the cooling medium cooled and lubricated the bearings 4A, 4B flow below the housing 3 by the action of gravity. This cooling medium passes through the cooling medium recovery passage 7B and is discharged to the outside of the housing 3. The cooling medium discharged to the outside of the housing 3 passes through the first cooling medium piping CL1 and is sucked by the pump 8. The pump 8 discharges the sucked cooling medium to the second cooling medium piping CL2. In this way, in the cooling structure 2, using the pump 8, the cooling medium is circulated among the motor 1, the first cooling medium piping CL1, the second cooling medium piping CL2, the shaft side supply piping CLA, and the coil end side supply piping CLB. Then, the cooling structure 2 repeats the cooling of the rotor core 20 and the coil end 6CE and the lubrication and cooling of the bearings 4A, 4B described above. It should be noted that a filter, which removes a foreign matter from the cooling medium, may be provided at the first cooling medium piping CL1 and the second cooling medium piping CL2. Additionally, a cooler cooling the cooling medium, which has cooled the rotor core 20 and the coil end 6CE and has a raised temperature, may be provided at the first cooling medium piping CL1. It should be noted that, besides the above-described circulation structure of the cooling medium, means of supplying the cooling medium to the coil end cooling passage 7T may have a circulation structure by providing a new supply pump of the cooling medium different from the pump 8 and supplying the cooling medium to the coil end cooling passage 7T. In other words, the motor 1 may have a dedicated cooling circuit to the coil end cooling passage 7T. Further, the cooling structure 2 can be applied regardless of whether the motor 1 has a magnet or not.

Next, as an example of a work vehicle, to which the motor according to the present embodiment is applied, a wheel loader which is a type of a construction vehicle will be described. An object, to which the motor of the present embodiment is applied, is not limited to the construction vehicle and not limited to the wheel loader among the construction vehicles.

<Wheel Loader>

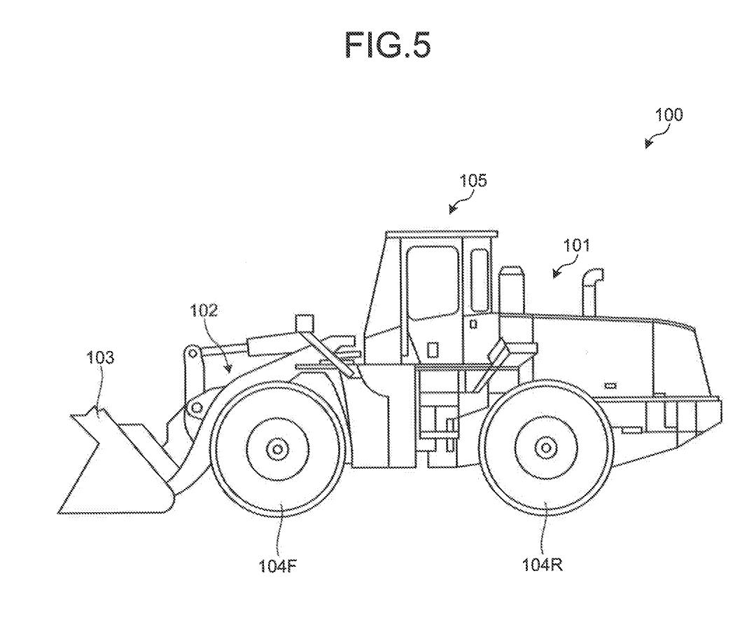

FIG. 5 is an explanatory diagram illustrating a wheel loader. A wheel loader 100 includes a vehicle body 101, a lift arm (work machine) 102 installed on a front part of the vehicle body 101, a bucket (work machine) 103 mounted to a tip of the lift arm 102, two front wheels 104F and two rear wheels 104R which rotate while supporting the vehicle body 101 and cause the vehicle body 101 to travel, and a cab 105 mounted on an upper part of the vehicle body 101.

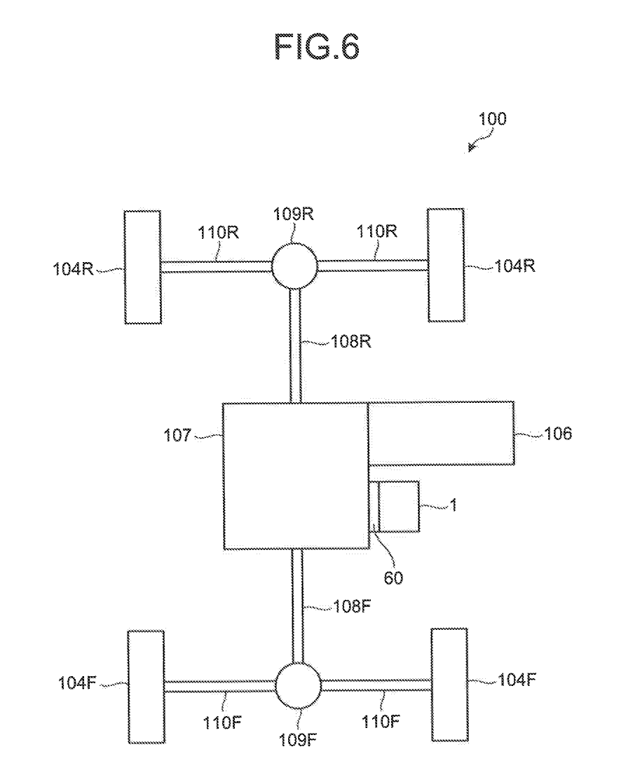

FIG. 6 is an exemplary diagram illustrating a drive system of the wheel loader. In the present embodiment, the wheel loader 100 has an internal combustion engine 106, such as a diesel engine or a gasoline engine, and the motor 1 as power generation sources. In this way, the drive system of the wheel loader 100 is a so-called hybrid system. In the present embodiment, the wheel loader 100 includes the one motor 1, but the number of the motors 1 is not limited to this.

An output of the internal combustion engine 106 is input to the transmission device 107. In the present embodiment, the output of the motor 1 is input to the transmission device 107 via the speed reduction device 60. After combining the outputs of the internal combustion engine 106 and the motor 1, the transmission device 107 outputs to a front wheel side propeller shaft 108F and a rear wheel side propeller shaft 108R. An output of the front wheel side propeller shaft 108F is transmitted to the two front wheels 104F via a front wheel side differential gear 109F and front wheel side drive shafts 110F. Further, an output of the rear wheel side propeller shaft 108R is transmitted to the two rear wheels 104R via a rear wheel side differential gear 109R and rear wheel side drive shafts 110R. In this way, the outputs of the internal combustion engine 106 and the motor 1 are transmitted to the front wheel 104F and the rear wheel 104R, thereby causing the wheel loader 100 to travel.

At the time of operating the wheel loader 100, there is also a case where only the output of the motor 1 or the output of the internal combustion engine 106 is transmitted to the transmission device 107. In other words, at the time of operating the wheel loader 100, the output of the motor 1 and the output of the internal combustion engine 106 are not always transmitted to the transmission device 107. Moreover, the number of the motors 1 is not limited to one and may be plural. Further, the wheel loader 100 has an inverter, which controls an operation (powering or regeneration) of the motor 1, and a power storage device, such as a capacitor or a secondary battery, which stores energy (electric power) obtained by the regeneration of the motor 1. It should be noted that in the present embodiment, the wheel loader 100 may be an electric vehicle (work vehicle or construction vehicle), which does not have an internal combustion engine and uses the motor 1 as a drive source by the electric power of the power storage device. In other words, the motor 1 according to the present embodiment can be applied to any hybrid vehicle or electric vehicle.

In the present embodiment, the motor 1 and the internal combustion engine 106 are placed horizontally. In other words, the motor 1 and the internal combustion engine 106 are disposed in such a manner that power transmission shafts of the motor 1 and the internal combustion engine 106 are orthogonal to a travel direction during straight traveling of the wheel loader 100, and more specifically, are orthogonal to the front wheel side propeller shaft 108F and the rear wheel side propeller shaft 108R. It should be noted that an arrangement of the motor 1 and the internal combustion engine 106 is not limited to the horizontal arrangement, and that the motor 1 and the internal combustion engine 106 may be placed vertically, that is, disposed in such a manner that the power transmission shafts thereof are parallel to the front wheel side propeller shaft 108F and the rear wheel side propeller shaft 108R.

Hereinabove, the motor according to the present embodiment includes the shaft, to which the gear can be mounted on the one end side, the bearing which rotatably supports the shaft relative to the housing further on the gear side than the rotor core, the tubular collar which is mounted to the outer peripheral section of the shaft and between the bearing and the gear, and the bearing mounting member which is mounted to the inner side of the above-described housing from the rotor core side and mounts the bearing to the housing. Accordingly, since the thrust force generated by the rotation of the gear is transmitted to the housing of the motor, the movement of the bearing in the rotation center axis direction can be suppressed. In this way, the motor according to the present embodiment is capable of reducing the effect of the thrust force generated by the rotation of the gear on the motor.

Further, with the construction described above, since the reduction of the bending rigidity of the shaft can be suppressed, and also the passing of the lubrication oil between the collar and the shaft can be avoided, the possibility that the lubrication oil enters the inside of the motor via the bearing can be reduced. Because of this, the motor according to the present embodiment is suitable for the application for avoiding entering of the lubrication oil into the motor, for example, the application in which the motor and the speed reduction device are disposed adjacently (e.g., for the travel of a construction machine, such as a wheel loader).

### REFERENCE SIGNS LIST

1 motor

2 cooling structure

3 housing

3R anti-shaft taking out side member

3S side section

3T shaft taking out side member

3TB bearing mounting section

4A first bearing (bearing)

4B second bearing (bearing)

4b rolling body

4e outer ring

4i inner ring

5A, 5B sealing member

6 stator

10 shaft

10C one end

10NG gear retaining ring

10NR rotor core fixing nut

10R another end

10S outer peripheral section

10p cooling medium supply groove

11 cooling medium supply passage

12 bearing mounting member

14 rotor core fixing section

15, 17 lubrication oil passage

18 bearing locking section

19 step section

20 rotor core

50 collar

53 groove

60 speed reduction device

61 housing

65 power transmission shaft

70 planetary gear unit

71 gear

72 pinion gear

73 carrier

74 ring gear

100 wheel loader

1. A motor having an annular stator mounted to an inner side of a tubular housing and a rotor core disposed inward of the stator in a radial direction of the stator, comprising:
a shaft which is mounted to the rotor core, and which extends in a direction of a rotation center axis of the rotor core, a gear being able to be mounted on one end side of the shaft;
a bearing which rotatably supports the shaft to the housing on a side of the gear than the rotor core;
a tubular collar which is mounted to an outer peripheral section of the shaft and between the bearing and the gear; and
a bearing mounting member which is mounted to an inner side of the housing from a side of the rotor core and mounts the bearing to the housing.

2. The motor according to claim 1, wherein a sealing member is provided at an outer peripheral section of the collar.

3. The motor according to claim 1, wherein the collar has a passage which extends from an inner peripheral section of the collar to the outer peripheral section of the collar.

4. The motor according to claim 1, wherein a sealing member is provided at an outer peripheral section of the collar, and the collar has a passage which extends from an inner peripheral section of the collar to the outer peripheral section of the collar, and
an opening section of the passage on a side of the outer peripheral section is connected between the bearing and the sealing member.

5. The motor according to claim 2, wherein the two sealing members are provided in the direction of the rotation center axis.

6. The motor according to claim 5, wherein a space between the two sealing members is connected to a gas reservoir.

7. The motor according to claim 1, wherein a speed reduction device is mounted to the housing, and the gear is an input section of the speed reduction device.

8. The motor according to claim 6, wherein the speed reduction device has a planetary gear unit, and the gear is a sun gear of the planetary gear unit.

9. A motor having an annular stator mounted to an inner side of a tubular housing and a rotor core disposed inward of the stator in a radial direction of the stator, comprising:
a shaft which is mounted to the rotor core, and which extends in a direction of a rotation center axis of the rotor core, a gear being able to be mounted on one end side of the shaft;
a bearing which rotatably supports the shaft to the housing further on a side of the gear than the rotor core;
a tubular collar which is mounted to an outer peripheral section of the shaft and between the bearing and the gear and which has a passage extending from an inner peripheral section to an outer peripheral section;
a bearing mounting member which is mounted to an inner side of the housing from a side of the rotor core and mounts the bearing to the housing; and
a sealing member which is provided between the collar and the housing and suppresses a flow of a fluid between the housing and an outside of the housing,
wherein an opening section of the passage on the outer peripheral section side of the collar is connected between the bearing and the sealing member.

10. The motor according to claim 9, wherein an inside of the housing is cooled by a cooling medium.

11. The motor according to claim 1, wherein an inside of the housing is cooled by a cooling medium.
